(19) United States
(12) Patent Application Publication
(10) Pub. No.: US 2009/0096900 A1
(43) Pub. Date: Apr. 16, 2009

(54) IMAGE SENSOR DEVICE

(76) Inventors: Chin-Poh PANG, Hsinchu (TW); Wu-Chieh Liu, Keelung (TW)

Correspondence Address: Joe McKinney Muncy, PO Box 1364, Fairfax, VA, 22038-1364, US

(21) Appl. No.: 11/871,074

(22) Filed: Oct. 11, 2007

(51) Int. Cl. H04N 5/335

(52) U.S. Cl. 348/294; 348/E05.091

(57) ABSTRACT

An image sensor device is disclosed. The device comprises a plurality of unit pixels, and each unit pixel comprises a substrate and a non-absorptive color separating device overlying the substrate. The substrate comprises a plurality of photodiodes horizontally arranged in a row, and at least one bevel boundary area between the photodiodes. The non-absorptive color separating device disperses incident white light into components thereof arranged in the row according to a gradient of wave lengths of the components of white light, and introduces the components of white light to the photodiodes.

### BACKGROUND OF THE INVENTION

1. Field of the Invention

The invention relates to semiconductor technology and more particularly to an image sensor device.

2. Description of the Related Art

Conventionally, for image sensor devices, devices use p-n junctions or p-i-n junctions of compound semiconductors such as crystalline silicon, amorphous silicon and GaAs. These image sensor devices are two-dimensionally arranged to form a plane-type image sensor device, or one-dimensionally arranged to form a line sensor.

For a color image sensor devices and line sensor, a color filter system in which color filters each allow light of a specific wavelength range to pass through is generally used for color separation. Examples of color filter systems include a color filter system in which color filters of three primary colors: red (hereinafter abbreviated as R), green (hereinafter abbreviated as G) and blue (hereinafter abbreviated as B) are disposed, and complementary color filters involving color separation into cyanogen, magenta, yellow and green are also disposed.

However, the described color filter system has a problem of decreased light amount due in part to the light being absorbed by the color filter. Thus, an optical lowpass filter is required for preventing the problem of light loss.

### BRIEF SUMMARY OF THE INVENTION

Embodiments of the invention provide image sensor devices that prevent a loss of light when processing light.

An embodiment of the invention further provides an image sensor device comprising a plurality of unit pixels, and each unit pixel comprises a substrate and a non-absorptive color separating device overlying the substrate. The substrate comprises a plurality of photodiodes horizontally arranged in a row, and at least one bevel boundary area between the photodiodes. The non-absorptive color separating device disperses incident white light into components thereof arranged in the row according to a gradient of wave lengths of the components of white light, and introduces the components of white light to the photodiodes.

An embodiment of the invention further provides an image sensor device comprising a plurality of unit pixels, and each unit pixel comprises a substrate, at least one bevel boundary area, a plurality of photodiodes, and a non-absorptive color separating device overlying the substrate. The substrate has a rectangular unit pixel area in a surface. At least one bevel boundary area divides the unit pixel area into a plurality of photodiode areas arranged in a row. The photodiodes are respectively disposed in the photodiode areas. The non-absorptive color separates device dispersing incident white light into components thereof arranged in the row according to a gradient of wave lengths of the components of white light, and introduces the components of white light to the photodiodes.

An embodiment of the invention further provides an image sensor device comprising a plurality of unit pixels, and each unit pixel comprises a substrate, a non-absorptive color separating device, and a photodiode contact. The substrate comprises a first surface and a second surface opposing the first surface. The substrate comprises a plurality of photodiodes horizontally arranged in a row and at least one bevel boundary area between the photodiodes. The non-absorptive color separating device overlies the first surface of the substrate. The non-absorptive color separating device disperses incident white light into components thereof arranged in the row according to a gradient of wave lengths of the components of white light, and introduces the components of white light to the photodiodes. The photodiode contact overlies the second surface of the substrate.

Further scope of the applicability of the invention will become apparent from the detailed description given hereinafter. It should be understood, however, that the detailed description and specific examples, while indicating preferred embodiments of the invention, are given by way of illustration only, as various changes and modifications within the spirit and scope of the invention will become apparent to those skilled in the Art from this detailed description.

A detailed description is given in the following embodiments with reference to the accompanying drawings.

### BRIEF DESCRIPTION OF THE DRAWINGS

The invention can be more fully understood by reading the subsequent detailed description and examples with references made to the accompanying drawings, wherein:

FIG. 1 shows a top view of an image sensor device of a preferred embodiment of the invention;

FIGS. 2A and 2B show cross-sections of one of the unit pixels of the image sensor device shown in FIG. 1;

FIGS. 3A through 3D show cross-sections of examples of the non-absorptive color separating device shown in FIG. 1: and

FIG. 4 shows a diagram of photodiode arrangement of the image sensor device shown in FIG. 2A.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

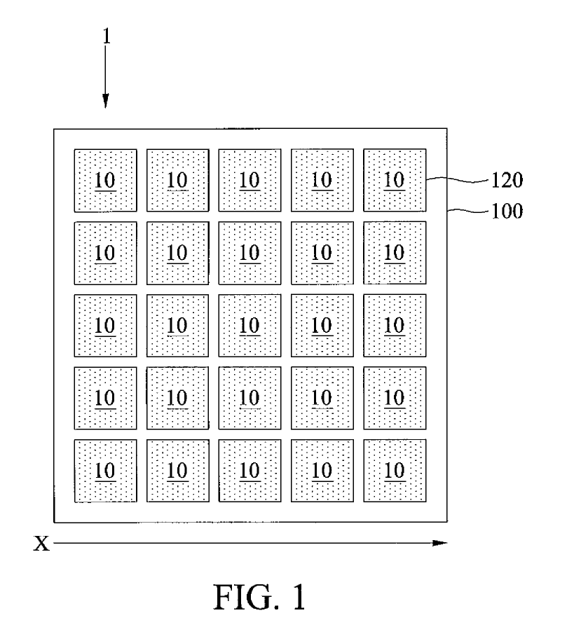

FIG. 1 shows a top view of an image sensor device 1 of a preferred embodiment of the invention. The image sensor device 1 comprises a plurality of unit pixels 10, and comprises a non-absorptive color separating device 120 in each unit pixel 10 overlying a substrate 100 comprising photodiodes. Further, the arrow marked X indicates a reference row direction. In this embodiment, the unit pixels 10 are arranged in a matrix. In other embodiments, the unit pixels 10 may be arranged in a row or in a column. In yet other embodiments, the unit pixels 10 may be arranged randomly.

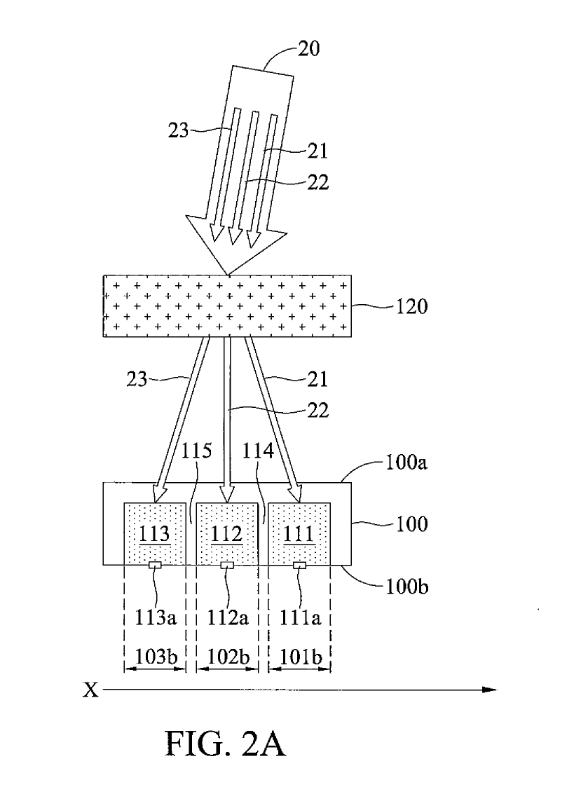

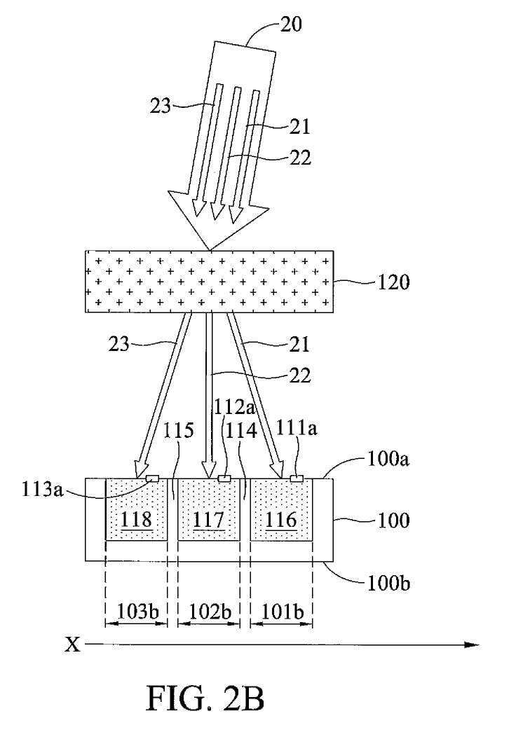

FIGS. 2A and 2B show cross-sections of one of the unit pixels 10 of the image sensor device 1 shown in FIG. 1. In FIG. 2A, the image sensor device 1 is a back-illuminated device. In FIG. 2B, the image sensor device 1 is a front-illuminated device.

In FIG. 2A, the substrate 100 comprises a first surface 100a and a second surface 100b opposing the first surface 100b. In this embodiment, the first surface 100a receives the light illumination and photodiode electrodes and periphery circuit of the image sensor device 1 is formed on the second surface 100b, and thus, the image sensor device 1 is a back-illuminated device in this embodiment because the second surface 100b acts as the front surface of the device and the first surface 10a acts as the back surface of the device.

The substrate 100 comprises a plurality of photodiodes horizontally arranged in a row indicated by the arrow marked X. In FIGS. 2A and 2B of the preferred embodiments of the invention, the substrate 100 comprises three photodiodes in each unit pixel 10. Note that the quantity of photodiodes in each unit pixel shown in FIGS. 2A and 2B are exemplary, and not intended to limit the scope of the invention. Those skilled in the Art will recognize the possibility of using various quantities of photodiodes in each unit pixel as desired.

In FIG. 2A, the substrate 100 comprises photodiodes 111, 112, and 113 horizontally arranged in a row indicated by the arrow marked X. Specifically, the second surface 100b of the substrate 100 comprises photodiode areas 101b, 102b, and 103b horizontally arranged in a row indicated by the arrow marked X, and the photodiodes 111, 112, and 113 are disposed in the photodiode areas 101b, 102b, and 103b respectively. A bevel boundary area 114 is disposed between the photodiodes 111 and 112, and a bevel boundary area 115 is disposed between the photodiodes 112 and 113. How the bevel boundary areas 114 and 115 are “bevel” is subsequently shown and described. In this embodiment, the photodiodes 111, 112, and 113 detect visible light. In some embodiments, the substrate 100 may comprise other photodiodes for detecting other types of electromagnetic waves, such as infrared rays, ultraviolet (UV) rays, or other electromagnetic waves. The photodiodes 111, 112, and 113 respectively comprise photodiode electrodes 111a, 112a, and 113a on the second surface 100b of the substrate 100. The photodiode electrodes 111a, 112a, and 113a are not on the first surface 100a for receiving light illumination, and thus, do not affect the effective illumination area of the photodiodes 111, 112, and 113. Periphery circuit may be provided on the second surface 100b for the photodiodes 111, 112, and 113, but is not shown for brevity.

The substrate 100 is a semiconductor substrate comprising any known element or compound semiconductor materials, but is a silicon substrate in this embodiment. The photodiode areas 101b, 102b, and 103b are respectively doped with known n-type or p-type impurities for formation of the photodiodes 111, 112, and 113. In this embodiment, the substrate 100 may comprise a suitable thickness for light passing through the substrate 100 and maintaining enough substrate strength. Any person skilled in the art can achieve his optimum substrate thickness through routine experimentation.

The non-absorptive color separating device 120 overlies the substrate 100. In some embodiments, the non-absorptive color separating device 120 is formed on either the first surface 100a or the second surface 100b of the substrate 100. In some embodiments, the non-absorptive color separating device 120 may be formed on the other substrate opposite to the substrate 100. In this embodiment, the non-absorptive color separating device 120 overlies the first surface 100a of the substrate 100.

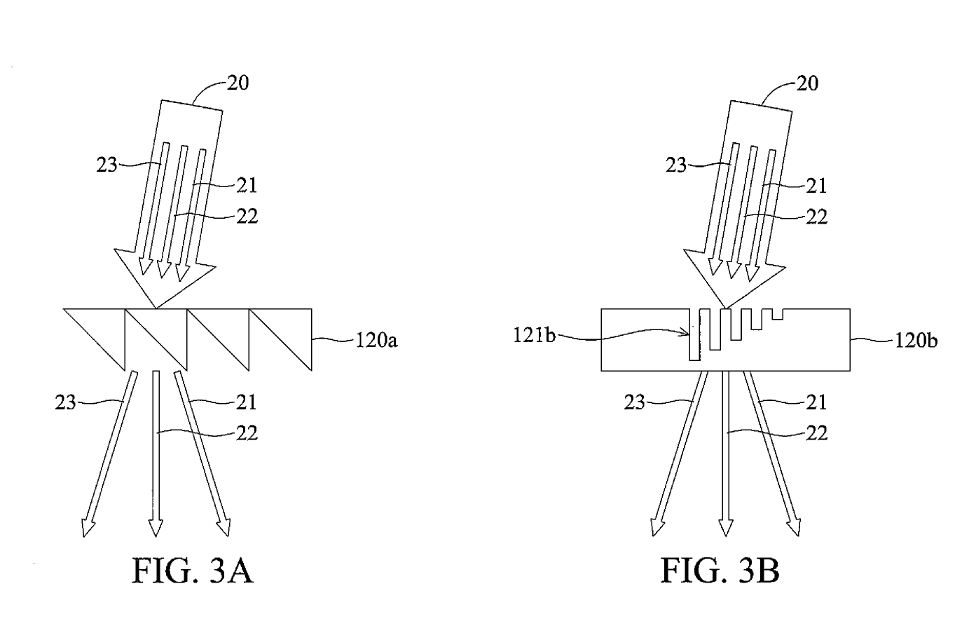

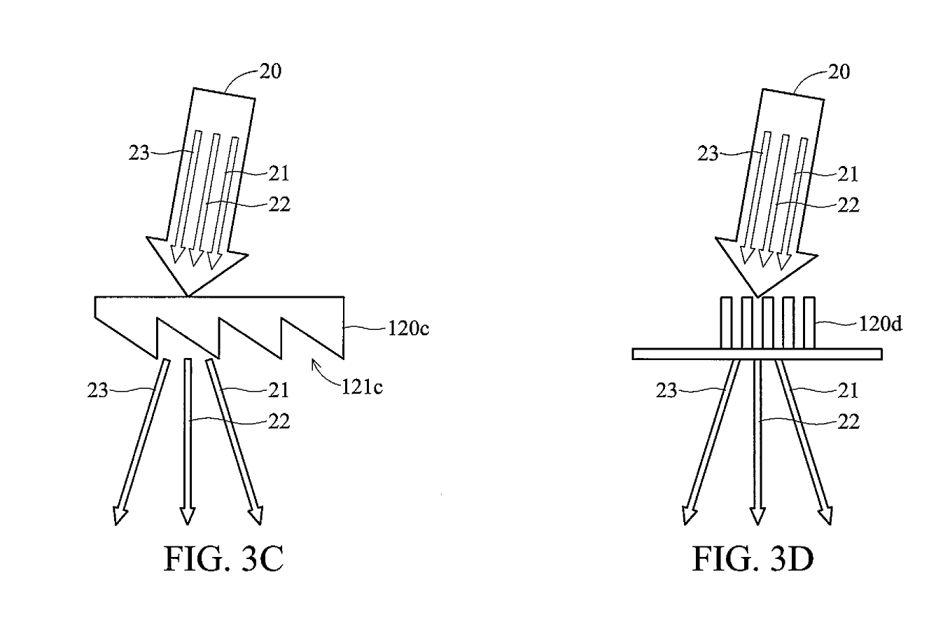

The non-absorptive color separating device 120 disperses incident white light 20 into components thereof arranged in the row indicated by the arrow marked X according to a gradient of wave lengths of the components of white light, and introducing the components of white light 20 to the photodiodes. In FIG. 2A, for example, the photodiodes 111, 112, and 113 are respectively designed for detecting red, green, and blue lights, and the non-absorptive color separating device 120 disperses incident white light 20 from the environment or a light source (not shown) into components thereof with an order of red light 21, green light 22, and blue light 23, arranged in the row indicated by the arrow marked X. The non-absorptive color separating device 120 introduces red light 21 to the photodiode 111, green light 22 to the photodiode 112, and blue light 23 to the photodiode 113. The non-absorptive color separating device 120 may be selected from a group consisting of a prism, a diffractive prism, a phase grating, and a blazed grating, exemplary shown in FIGS. 3A through 3D.

In FIG. 2B, the substrate 100 comprises photodiodes 116, 117, and 118 horizontally arranged in a row indicated by the arrow marked X. Specifically, the first surface 100a of the substrate 100 comprises photodiode areas 101a, 102a, and 103a horizontally arranged in a row indicated by the arrow marked X, and the photodiodes 116, 117, and 118 are disposed in the photodiode areas 101a, 102a, and 103a respectively. A bevel boundary area 119a is disposed between the photodiodes 116 and 117, and a bevel boundary area 119b is disposed between the photodiodes 117 and 118. How the bevel boundary areas 119a and 119b are “beveled” is similar with bevel boundary areas 114 and 115 subsequently shown and described. In this embodiment, the photodiodes 116, 117, and 118 are respectively designed for detecting red, green, and blue lights. In some embodiments, the substrate 100 may comprise other photodiodes for detecting other types of electromagnetic waves, such as infrared rays, ultraviolet (UV) rays, or other electromagnetic waves. The photodiodes 116, 117, and 118 respectively comprise photodiode electrodes 116a, 117a, and 118a on the first surface 100a of the substrate 100. The photodiode electrodes 116a, 117a, and 118a are on the first surface 100a for receiving light illumination, and thus, slightly affect the effective illumination area of the photodiodes 116, 117, and 118. A periphery circuit may be provided on the first surface 100a for the photodiodes 116, 117, and 118, but is not shown for brevity. Further, details regarding the substrate 100, the non-absorptive color separating device 120, and lights 20-23, are respectively similar to those described for FIG. 2A, and thus, are omitted herefrom.

FIGS. 3A through 3D show cross-sections of examples of the non-absorptive color separating device 120 shown in FIG. 1, and ignore the substrate 100 for brevity.

In FIG. 3A, the non-absorptive color separating device 120 is a prism 120a or a set of prisms 120a dispersing incident white light 20 from the environment or a light source (not shown) into components thereof with an order of red light 21, green light 22, and blue light 23. Thus, the non-absorptive color separating device 120 does not substantially absorb energy from incident white light 20. The arrangement of the prism 120a or the set of prisms 120a depends on a predetermined color spectrum of red light 21, green light 22, and blue light 23.

In FIG. 3B, the non-absorptive color separating device 120 is a diffractive prism. The diffractive prism comprises a transparent film 120b, such as silicon oxide, or other transparent materials, which is patterned by lithography and etching, for example, to form a pattern 121b of a plurality of trenches dispersing incident white light 20 from the environment or a light source (not shown) into components thereof with an order of red light 21, green tight 22, and blue light 23. Thus, the non-absorptive color separating device 120 does not substantially absorb energy from incident white light 20. The pattern 121b comprises a plurality of trenches with different depths, and is designed depending on a predetermined color spectrum of red light 21, green light 22, and blue light 23.

In FIG. 3C, the non-absorptive color separating device 120 is a phase grating. The phase grating comprises a transparent film 120b, such as silicon oxide, with a sawtooth-like surface 121c dispersing incident white light 20 from the environment or a light source (not shown) into components thereof with an order of red light 21, green light 22, and blue light 23. Thus, the non-absorptive color separating device 120 does not substantially absorb energy from incident white light 20. The sawtooth-like surface 121c may be patterned by utilization of a gray-tone reticle, for example. The sawtooth-like surface 121c is designed depending on a predetermined color spectrum of red light 21, green light 22, and blue light 23.

In FIG. 3D, the non-absorptive color separating device 120 is a blazed grating. The blazed grating may comprise a plurality of opaque posts 120d arranged with predetermined pitches dispersing incident white light 20 from the environment or a light source (not shown) into components thereof with an order of red light 21, green light 22, and blue light 23. Thus, the non-absorptive color separating device 120 does not substantially absorb energy from incident white light 20. In some embodiments, the opaque posts 120d may comprise metal. The pattern and pitch of the opaque posts 120d depend on a predetermined color spectrum of red light 21, green light 22, and blue light 23.

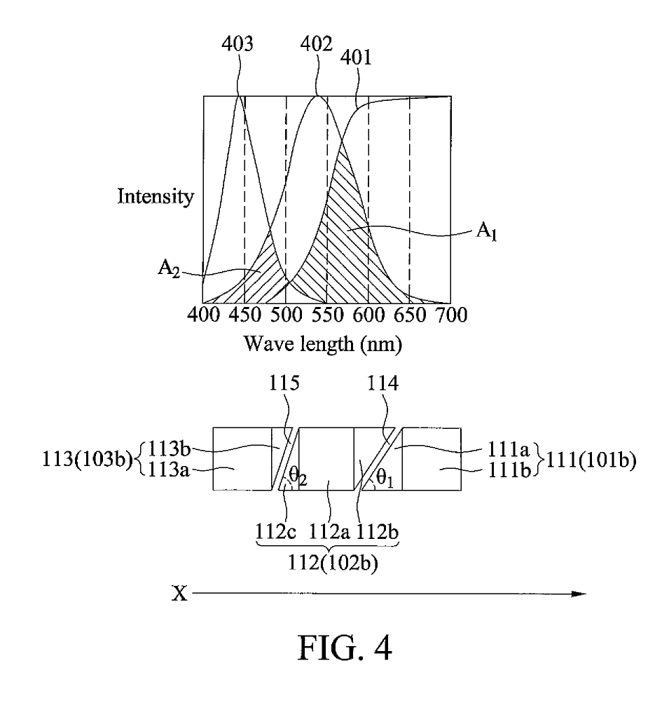

FIG. 4 shows a diagram of photodiode arrangement of the image sensor device shown in FIG. 2A. The upper potion of FIG. 4 shows an exemplary color spectrum diagram of red light 21, green light 22, and blue light 23 from the non-absorptive color separating device 120. In the color spectrum diagram, the X axis indicates light wave length from the non-absorptive color separating device 120, and the Y axis indicates light intensity. The curves 401, 402, and 403 respectively indicate the spectrums of red light 21, green light 22, and blue light 23 from the non-absorptive color separating device 120. The area A1 indicates color cross-talk between the red light 21 and the green light 22 from the non-absorptive color separating device 120, and the area A2 indicates color cross-talk between the green light 22 and the blue light 23 from the non-absorptive color separating device 120. Further, the X axis of the color spectrum diagram also indicates positions in the photodiodes 111, 112, and 113 in the substrate 100 as shown in FIG. 2A. For example a light beam of wave length 400 nm illuminates the left edge of the photodiode 113 shown in FIG. 2A, and a light beam of wave length 700 nm illuminates the right edge of the photodiode 111 shown in FIG. 2A. For the light beams of wave lengths between 400 nm and 700 nm, the longer the wavelength, the closer the illumination position to the right edge of the photodiode 111 shown in FIG. 2A and the farther the illumination position from the left edge of the photodiode 113 shown in FIG. 2A.

The lower portion of FIG. 4 is a bottom view of the photodiodes 111, 112, and 113 from the second surface 100b shown in FIG. 2A. Also for the light beams of wave length between 400 nm and 700 nm, the longer the wavelength, the closer the illumination position to the right edge of the photodiode 111 and the farther the illumination position from the left edge of the photodiode 113. The photodiodes 111, 112, and 113 (photodiode areas 101b, 102b, and 103b) and the bevel boundary areas 114 and 115 therebetween define a light detection area of the substrate 100. In this embodiment, the light detection area is rectangular or substantially rectangular. In other embodiments, the light detection area can be other shapes as desired. The bevel boundary areas 114 and 115 divide the light detection area into the photodiode areas 111b, 102b, and 103b respectively for the photodiodes 111, 112, and 113 which are arranged in the row indicated by the arrow marked X. The bevel boundary areas 114 and 115 further define transitional portions of photodiodes 111, 112, and 113 for detecting light beams in color cross talk areas A1 and A2.

For example, the bevel boundary area 114 defines a bevel angle θ₁ between the photodiodes 111 and 112, and the bevel boundary area 115 defines a bevel angle θ₂ between the photodiodes 112 and 113. The bevel angle θ₁ and the bevel angle θ₂ are both acute angles. The values of θ₁ and θ₂ depend on color cross talk areas A1 and A2. In this embodiment, color cross talk area A1 is preferably greater than color cross talk area A2, and thus, the bevel angle θ₁ is less than the bevel angle θ₂. Thus, the transitional portion between the photodiodes 111 and 112 for detecting light beams from the greater color cross talk area A1 is greater than the transitional portion between the photodiodes 112 and 113 for detecting light beams from the color cross talk area A2.

Specifically in this embodiment, as the light detection area is rectangular, the photodiodes 111 and 113 (photodiode areas 101b and 103b) are both trapezoids consisting of two right angles and the photodiode 112 (photodiode area 102b) is a trapezoid without a right angle. Further, the bevel boundary areas 114 and 115 are both parallelograms or substantially parallelogram in this embodiment. As defined by the bevel boundary areas 114 and 115 of parallelograms, the photodiode 111 comprises a rectangular or substantially rectangular main portion 111a farther from the bevel boundary area 114, and a green transitional portion 111b of right-angled triangle closer to the bevel boundary area 114. Similarly, the photodiode 112 comprises a rectangular or substantially rectangular main portion 112a farther from the bevel boundary areas 114 and 115, a red transitional portion 112b of right-angled triangle closer to the bevel boundary area 114, and a blue transitional portion 112c of right-angled triangle closer to the bevel boundary area 115. Similarly, the photodiode 113 comprises a rectangular or substantially rectangular main portion 113a farther from the bevel boundary area 115, and a green transitional portion 113b of right-angled triangle closer to the bevel boundary area 114. Further, the bevel angle θ₁ is the bevel angle of the photodiode 111 pointing to the photodiode 112, and the bevel angle θ₂ is the bevel angle of the photodiode 112 pointing to the photodiode 113. Because the bevel angle θ₁ is less than the bevel angle θ₂ as described, the green transitional portion 111b is greater than the green transitional portion 113b, and the red transitional portion 112b is greater than the blue transitional portion 112c. Thus, the transitional portion between the photodiodes 111 and 112 for detecting light beams from the greater color cross talk area A1 is greater than the transitional portion between the photo diodes 112 and 113 for detecting light beams from the color cross talk area A2. As a result, the performance of the image sensor device 1 is improved.

As described, the efficacy of the inventive image sensor device provides substantially no light loss during light dispersion and transitional portions between different photodiodes, improving the performance of the image sensor device.

While the invention has been described by way of example and in terms of preferred embodiment, it is to be understood that the invention is not limited thereto. To the contrary, it is intended to cover various modifications and similar arrangements (as would be apparent to those skilled in the Art). Therefore, the scope of the appended claims should be accorded the broadest interpretation so as to encompass all such modifications and similar arrangements.

What is claimed is:

1. An image sensor device comprising a plurality of unit pixels, each unit pixel comprising:
a substrate comprising a plurality of photodiodes horizontally arranged in a row and at least one bevel boundary area between the photodiodes; and
a non-absorptive color separating device overlying the substrate, the non-absorptive color separating device dispersing incident white light into components thereof arranged in the row according to a gradient of wave lengths of the components of white light, and introducing the components of white light to the photodiodes.

2. The device as claimed in claim 1, wherein the non-absorptive color separating device is selected from a group consisting of a prism, a diffractive prism, a phase grating, and a blazed grating.

3. The device as claimed in claim 1, wherein
the photodiodes comprise a second photodiode horizontally sandwiched by a first photodiode and a third photo diode; and
a first bevel boundary area is disposed between the first and second photodiodes, and a second bevel boundary area is disposed between the second and third photodiodes.

4. The device as claimed in claim 3, wherein
the first photodiode is for receiving red light, the second photodiode is for receiving green light, and the third photodiode is for receiving blue light; and
the components of white light dispersed by the non-absorptive color separating device arranged in an order of red, green, and blue lights corresponding to the first, second, and third photodiodes.

5. The device as claimed in claim 4, wherein a first acute angle of a first bevel angle between the first and second photodiodes is less than a second acute angle of a second bevel angle between the second and third photodiodes.

6. An image sensor device comprising a plurality of unit pixels, each unit pixel comprising:
a substrate having a rectangular unit pixel area in a surface;
at least one bevel boundary area dividing the unit pixel area into a plurality of photodiode areas arranged in a row;
a plurality of photodiodes respectively disposed in the photodiode areas; and
a non-absorptive color separating device overlying the substrate, the non-absorptive color separating device dispersing incident white light into components thereof arranged in the row according to a gradient of wave lengths of the components of white light, and introducing the components of white light to the photodiodes.

7. The device as claimed in claim 6, wherein the non-absorptive color separating device is selected from a group consisting of a prism, a diffractive prism, a phase grating, and a blazed grating.

8. The device as claimed in claim 6, wherein
the photodiodes comprise a second photodiode in a second photodiode area sandwiched by a first photodiode in a first photodiode area and a third photodiode in a third; and
a first bevel boundary area is disposed between the first and second photodiode areas, and a second bevel boundary area is disposed between the second and third photodiode areas.

9. The device as claimed in claim 8, wherein
the first photodiode is for receiving red light, the second photodiode is for receiving green light, and the third photodiode is for receiving blue light; and
the components of white light dispersed by the non-absorptive color separating device arranged in an order of red, green, and blue lights corresponding to the first, second, and third photodiodes.

10. The device as claimed in claim 9, wherein
the first and third photodiode areas are trapezoids, each consisting of two right angles; and
the second photodiode area is a trapezoid without a right angle.

11. The device as claimed in claim 10, wherein
the first photodiode comprises a first acute angle of a first bevel angle pointing to the second photodiode, and the second photodiode area comprises a second acute angle of a second bevel angle pointing to the third photodiode area; and
the first acute angle is less than the second acute angle.

12. An image sensor device comprising a plurality of unit pixels, each unit pixel comprising:
a substrate comprising a first surface and a second surface opposing the first surface, the substrate comprising a plurality of photodiodes horizontally arranged in a row and at least one bevel boundary area between the photodiodes;
a non-absorptive color separating device overlying the first surface of the substrate, the non-absorptive color separating device dispersing incident white light into components thereof arranged in the row according to a gradient of wave lengths of the components of white light, and introducing the components of white light to the photodiodes; and
a photodiode contact overlying the second surface of the substrate.

13. The device as claimed in claim 12, wherein the non-absorptive color separating device is selected from a group consisting of a prism, a diffractive prism, a phase grating, and a blazed grating.

14. The device as claimed in claim 12, wherein
the photodiodes comprise a second photodiode horizontally sandwiched by a first photodiode and a second photodiode; and
a first bevel boundary area is disposed between the first and second photodiodes, and a second bevel boundary area is disposed between the second and third photodiodes.

15. The device as claimed in claim 14, wherein
the first photodiode is for receiving red light, the second photodiode is for receiving green light, and the third photodiode is for receiving blue light; and
the components of white light dispersed by the non-absorptive color separating device arranged in an order of red, green, and blue lights corresponding to the first, second, and third photodiodes.

16. The device as claimed in claim 15, wherein a first acute angle of a first bevel angle between the first and second photodiodes is less than a second acute angle of a second bevel angle between the second and third photodiodes.

17. The device as claimed in claim 15, wherein the first photodiode, the first bevel boundary area, the second photodiode, the second bevel boundary area, and the third photodiode are arranged rectangular.

18. The device as claimed in claim 17, wherein
the first and third photodiodes are trapezoids, each consisting of two right angles; and
the second photodiode is a trapezoid without a right angle.

19. The device as claimed in claim 18, wherein
the first photodiode comprises a first acute angle of a first bevel angle pointing to the second photodiode, and the second photodiode comprises a second acute angle of a second bevel angle pointing to the third photodiode; and
the first acute angle is less than the second acute angle.
